(19) United States
(12) Patent Application Publication
(10) Pub. No.: US 2013/0302579 A1
(43) Pub. Date: Nov. 14, 2013

(54) METHOD OF PRODUCING INK CURED PRODUCT

(71) Applicants: TOYO INK CO., LTD., Chuo-ku (JP); TOYO INK SC HOLDINGS CO., LTD., Chuo-ku (JP)

(72) Inventors: Hiroyuki KUGE, Tokyo (JP); Yoshiki SATO, Tokyo (JP); Mikiko MAI, Tokyo (JP); Keiichi SATO, Tokyo (JP)

(21) Appl. No.: 13/836,307

(22) Filed: Mar. 15, 2013

(30) Foreign Application Priority Data
Mar. 31, 2011 (JP) 2011-079987
Mar. 29, 2012 (JP) 2012-077686

(51) Int. Cl. C09D 11/10

(52) U.S. Cl. CPC C09D 11/101
USPC 428/211.1; 427/487; 428/195.1

(57) ABSTRACT

A method of producing an ink cured product having a step of printing an active energy beam-curable ink comprising a monomer having an ethylenic double bond and a photopolymerization initiator onto a substrate, and then curing the active energy beam-curable ink with an active energy beam, wherein the monomer having an ethylenic double bond comprises an acrylate monomer having a molecular weight of 330 or less and containing 1 to 3 acryloyl groups, the photopolymerization initiator comprises three or more types of compounds selected from the group consisting of (A1) α-aminoalkylphenone compounds, (A2) acylphosphine oxide compounds, (B1) thioxanthone compounds and (B2) benzophenone compounds, and the substrate is either a paper having a high degree of smoothness or a plastic film.

### TECHNICAL FIELD

Embodiments of the present invention relate to a method of producing an ink cured product, an ink cured product, and a printed item.

### BACKGROUND ART

Conventionally, a variety of printing systems such as lithographic printing (either normal lithography that uses dampening water or waterless lithography that does not use dampening water), relief printing, intaglio printing and stencil printing have been employed to obtain all manner of printed items such as printed continuous forms, various types of printed books, various printed items for packaging such as cartons, various printed plastic items, printed items for stickers and labels, printed art and printed metal items (such as printed art items, printed beverage cans and printed food cans). In each of these printing systems, an ink that is suitable for that particular printing system is used. One known example of such an ink is an active energy beam-curable ink.

With conventional active energy beam-curable inks, curing is typically performed using a light source such as a mercury lamp or metal halide lamp, and conventional active energy beam-curable inks use a photopolymerization initiator that is appropriate for the emission wavelength of the light source. The above types of ultraviolet irradiation light sources have an emission band that spans a broad wavelength region, and therefore in conventional active energy beam-curable inks, photopolymerization initiators having different absorption wavelengths are combined (see JP 06-157962 A).

### SUMMARY OF INVENTION

Because conventional active energy beam-curable inks use a combination of photopolymerization initiators having different absorption wavelengths, ink curing using a typical mercury lamp or metal halide lamp is possible. However, if an ozone cut filter or infrared filter or the like is fitted to a metal halide lamp, high-pressure mercury lamp or electrodeless metal halide lamp or the like, thus forming a light source that emits ultraviolet light of 200 to 420 nm, or a light emitting diode (UV-LED) that emits ultraviolet light having an emission peak wavelength within a range from 350 to 420 nm is used, then satisfactory curing characteristics cannot be obtained.

In order to enable a conventional active energy beam-curable ink to be cured using a UV-LED, it would be desirable to use a photopolymerization initiator that exhibits absorption near a wavelength of 350 to 420 nm. However, the pigments used in inks often exhibit absorption of wavelengths from 350 to 420 nm, albeit at differing levels of absorption. Accordingly, even if a photopolymerization initiator that exhibits absorption near a wavelength of 350 to 420 nm is used, the photopolymerization initiator is unable to be imparted with sufficient light energy, resulting in inferior curability.

Further, another method that has been proposed for achieving curability by UV-LED involves the use of an ink composition comprising a combination of a specific a-aminoalkylphenone compound, an acylphosphine oxide compound, and a benzophenone compound. This ink composition enables a certain level of curing characteristics to be obtained, but recently, ink compositions having even better curability are being demanded (see WO 2009/008226, JP 4,289,441 B, JP 2009-035730 A, JP 2009-057546 A and JP 2009-057547 A).

Moreover, in those cases where a plastic film or a paper having a high degree of smoothness is used as the substrate, because the ability of the ink to penetrate into the substrate, the so-called anchoring effect, is minimal, further improvements in the adhesion are required.

Against a background of the circumstances described above, the inventors of the present invention discovered that by employing a method of producing an ink cured product that uses a specific active energy beam-curable ink and a specific substrate, an ink cured product having good curability and adhesion could be obtained, and they were therefore able to complete the present invention.

In other words, one embodiment of the present invention relates to a method of producing an ink cured product comprising a step of printing an active energy beam-curable ink comprising a monomer having an ethylenic double bond and a photopolymerization initiator onto a substrate, and then curing the active energy beam-curable ink with an active energy beam, wherein the monomer having an ethylenic double bond comprises an acrylate monomer having a molecular weight of 330 or less and containing 1 to 3 acryloyl groups, the photopolymerization initiator comprises three or more types of compounds selected from the group consisting of (A1) α-aminoalkylphenone compounds, (A2) acylphosphine oxide compounds, (B1) thioxanthone compounds and (B2) benzophenone compounds, and the substrate is either a paper having a property such that when the paper is secured to a mount having an angle of inclination of 50° and a single drop of 1,9-nonanediol diacrylate is dripped onto the paper from a 50 ml burette, the 1,9-nonanediol flows at least 10 cm in 30 seconds, or a plastic film.

Further, another embodiment of the present invention relates to an ink cured product produced using the above method of producing an ink cured product.

Moreover, yet another embodiment of the present invention relates to a printed item having a substrate and the ink cured product described above, wherein the substrate is either a paper having a property such that when the paper is secured to a mount having an angle of inclination of 50° and a single drop of 1,9-nonanediol diacrylate is dripped onto the paper from a 50 ml burette, the 1,9-nonanediol flows at least 10 cm in 30 seconds, or a plastic film.

The present application is related to the subject matter disclosed in prior Japanese Application 2011-079987 filed on Mar. 31, 2011, and prior Japanese Application 2012-077686 filed on Mar. 29, 2012; the entire contents of which are incorporated by reference herein.

### DESCRIPTION OF EMBODIMENTS

The active energy beam-curable ink used in the method of producing an ink cured product of an embodiment can achieve the same printing characteristics and curing characteristics as those obtained when curing is performed using a conventional high-pressure mercury lamp or metal halide lamp, even when a monochromatic UV-LED is used as the ultraviolet irradiation device. The active energy beam-curable ink used in the production method of the present embodiment has been designed to be ideal for use with light sources that emit ultraviolet light of 200 to 420 nm, including metal halide lamps, high-pressure mercury lamps and electrodeless metal halide lamps and the like that have been fitted with an ozone cut filter or infrared filter, and for use with monochromatic light such as light emitting diodes (UV-LED) that emit ultraviolet light within a range from 350 to 420 nm.

Of course, the active energy beam-curable ink can also be cured without any problems by using a typical high-pressure mercury lamp or metal halide lamp or the like.

The expression “active energy beam” describes an energy beam that can provide the energy necessary to excite the photopolymerization initiator used in the curing reaction from its ground state to a transition state. Specifically, an active energy beam refers to an ultraviolet light beam or an electron beam.

Methods of photocuring the active energy beam-curable inks generally use a light source that emits ultraviolet light, such as a high-pressure mercury lamp having electrodes, a metal halide lamp having electrodes, an electrodeless high-pressure mercury lamp or an electrodeless metal halide lamp. The method of photocuring the active energy beam-curable ink may use the general light sources described above, but preferably uses a light emitting diode (UV-LED) that emits ultraviolet light within a range from 350 to 420 nm.

The method of producing an ink cured product of an embodiment is a method of producing an ink cured product having a step of printing an active energy beam-curable ink comprising a monomer having an ethylenic double bond and a photopolymerization initiator onto a substrate, and curing the active energy beam-curable ink with an active energy beam, wherein

the monomer having an ethylenic double bond comprises an acrylate monomer having a molecular weight of 330 or less and containing 1 to 3 acryloyl groups, the photopolymerization initiator comprises three or more types of compounds selected from the group consisting of:
(A1) α-aminoalkylphenone compounds,
(A2) acylphosphine oxide compounds,
(B1) thioxanthone compounds, and
(B2) benzophenone compounds, and

the substrate is either:
a paper having a property such that when the paper is secured to a mount having an angle of inclination of 50° and a single drop of 1,9-nonanediol diacrylate is dripped onto the paper from a 50 ml burette, it flows at least 10 cm in 30 seconds, or
a plastic film.

If the active energy beam-curable ink is formed with a transparent composition by not including a pigment that functions as a colorant, then an OP varnish is obtained. Further, if a pigment such as those described below is included in the active energy beam-curable ink, then an ink for color printing such as a yellow, magenta, cyan or black ink is obtained.

When producing the ink cured product, because a plastic film or a paper having a high degree of smoothness is used as the substrate, penetration of the ink into the substrate, the so-called anchoring effect, is minimal, and therefore it is necessary to improve the ink adhesion. In the present embodiment, in order to improve this adhesion, a certain amount of a monomer having a molecular weight of 330 or less and containing 1 to 3 acryloyl groups is included in the ink, and this monomer is combined with a specific photopolymerization initiator.

There are no particular limitations on the substrate, provided it is either a plastic film or a paper having a high degree of smoothness, and either of these types of substrates may be used. Examples of paper substrates that can be used include coated papers, non-coated papers and other processed papers such as synthetic papers. The present embodiment is particularly effective for papers having a high degree of smoothness. Further, examples of the plastic film include olefin-based films such as polyethylene and polypropylene, polyester films typified by polyethylene terephthalate, and other plastic films such as cellophane, polyvinylidene chloride, polyvinylidene chloride copolymers, polyvinylidene fluoride, polyvinyl chloride, nylon, polyacrylic acid and polymethacrylic acid. Synthetic papers are papers produced using a synthetic resin as the main raw material, such as the product “YUPO” manufactured by Yupo Corporation.

A paper having a high degree of smoothness describes a paper having a property wherein when the paper is secured to a mount having an angle of inclination of 50° and a single drop of 1,9-nonanediol diacrylate is dripped onto the paper from a 50 ml burette, the 1,9-nonanediol flows at least 10 cm in 30 seconds. In other words, when a drop of the 1,9-nonanediol diacrylate is dripped from a 50 ml burette onto the paper having a high degree of smoothness, which has been secured to a mount having an angle of inclination of 50°, within 30 seconds, the drop of 1,9-nonanediol diacrylate has flowed a distance of at least 10 cm. The height of the outlet of the burette used for dripping the 1,9-nonanediol is set at 10 cm above the substrate, and measurement is performed in accordance with RS P-8137-1976 “Testing method of repellency of paper and paperboard”.

Examples of papers having a high degree of smoothness include OK Top Coat (manufactured by Oji Paper Co., Ltd., average flow distance over 10 tests: 11.8 cm), Tokubishi Art Double Sided N (manufactured by Mitsubishi Paper Mills Limited, average flow distance over 10 tests: 12.3 cm), Productolith (manufactured by NewPage Corporation, average flow distance over 10 tests: 12.2 cm), and Pearl Coat (manufactured by Mitsubishi Paper Mills Limited, average flow distance over 10 tests: 11.5 cm).

The monomer having an ethylenic double bond comprises an acrylate monomer having a molecular weight of 330 or less and containing 1 to 3 acryloyl groups. The monomer having an ethylenic double bond may also include a compound containing a (meth)acryloyl group other than the “acrylate monomer having a molecular weight of 330 or less and containing 1 to 3 acryloyl groups” (hereafter this other compound is referred to as simply a “compound having a (meth)acryloyl group”). The compound having a (meth)acryloyl group is a compound having at least one (meth)acryloyl group. Moreover, the monomer having an ethylenic double bond may also include a compound having an ethylenic double bond other than the “acrylate monomer having a molecular weight of 330 or less and containing 1 to 3 acryloyl groups” and the “compound having a (meth)acryloyl group” (hereafter this compound is referred to as simply a “compound having an ethylenic double bond”).

Examples of the monomer having an ethylenic double bond include the following compounds.

Examples of monofunctional monomers include alkyl (meth)acrylates having an alkyl group of 1 to 18 carbon atoms, such as methyl (meth)acrylate, ethyl (meth)acrylate, butyl (meth)acrylate, hexyl (meth)acrylate, octyl (meth)acrylate, dodecyl (meth)acrylate and stearyl (meth)acrylate, benzyl (meth)acrylate, (meth)acrylate esters of alkyl phenols such as butylphenol, octylphenol, nonylphenol or dodecylphenol, isobornyl (meth)acrylate, cyclohexyl (meth)acrylate, 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, hydroxypentyl (meth)acrylate, 2-hydroxy-3-phenoxypropyl (meth)acrylate, 2-hydroxy-3-butoxypropyl (meth)acrylate, 2-hydroxy-3-methoxypropyl (meth)acrylate, diethylene glycol mono(meth)acrylate, triethylene glycol mono(meth)acrylate, polyethylene glycol mono(meth)acrylate, dipropylene glycol mono(meth)acrylate, polypropylene glycol mono(meth)acrylate, glycerol mono(meth)acrylate, acryloyloxyethyl phthalate, 2-(meth)acryloyloxyethyl-2-hydroxyethyl phthalate, 2-(meth)acryloyloxypropyl phthalate, β-carboxyethyl (meth)acrylate, (meth)acrylic acid dimer, dimethylaminoethyl (meth)acrylate, diethylaminoethyl (meth)acrylate, N-vinylpyrrolidone, N-vinylformamide, and (meth)acryloylmorpholine.

Moreover, examples of difunetional monomers include ethylene glycol di(meth)acrylate, diethylene glycol di(meth)acrylate, triethylene glycol di(meth)acrylate, polyethylene glycol di(meth)acrylate, propylene glycol di(meth)acrylate, dipropylene glycol di(meth)acrylate, tripropylene glycol di(meth)acrylate, polypropylene glycol di(meth)acrylate, butylene glycol di(meth)acrylate, pentyl glycol di(meth)acrylate, neopentyl glycol di(meth)acrylate, hydroxypivalyl hydroxypivalate di(meth)acrylate (common name: Manda), hydroxypivalyl hydroxypivalate dicaprolactonate di(meth)acrylate, 1,6-hexanediol di(meth)acrylate, 1,2-hexanediol di(meth)acrylate, 1,5-hexanediol di(meth)acrylate, 2,5-hexanediol di(meth)acrylate, 1,7-heptanediol di(meth)acrylate, 1,8-octanediol di(meth)acrylate, 1,2-octanediol di(meth)acrylate, 1,9-nonanediol di(meth)acrylate, 1,2-decanediol di(meth)acrylate, 1,10-decanediol di(meth)acrylate, 1,2-decanediol di(meth)acrylate, 1,12-dodecanediol di(meth)acrylate, 1,2-dodecanediol di(meth)acrylate, 1,14-tetradecanediol di(meth)acrylate, 1,2-tetradecanediol diacrylate, 2-methyl-2,4-pentanediol di(meth)acrylate, 3-methyl-1,5-pentanediol di(meth)acrylate, 2-methyl-2-propyl-1,3-propanediol di(meth)acrylate, 2,4-dimethyl-2,4-pentanediol di(meth)acrylate, 2,2-diethyl-1,3-propanediol di(meth)acrylate, 2,2,4-trimethyl-1,3-pentanediol di(meth)acrylate, 2-ethyl-1,3-hexanediol di(meth)acrylate, 2,5-dimethyl-2,5-hexanediol di(meth)acrylate, 2-methyl-1,8-octanediol di(meth)acrylate, 2-butyl-2-ethyl-1,3-propanediol di(meth)acrylate, 2,4-diethyl-1,5-pentanediol di(meth)acrylate, hydrogenated bisphenol-A di(meth)acrylate, and hydrogenated bisphenol-F di(meth)acrylate.

Examples of trifunctional monomers include glycerol tri(meth)acrylate, trimethylolethane tri(meth)acrylate and trimethylolhexane tri(meth)acrylate. Further, examples of tetrafunctional or higher functional monomers include dipentaerythritol hexa(meth)acrylate.

Further examples of the monomer having an ethylenic double bond include alkylene oxide adduct (meth)acrylates of aliphatic alcohol compounds. Examples of these aliphatic alcohol compound alkylene oxide adduct (meth)acrylate monomers include mono or poly (1 to 10) (meth)acrylates of mono or poly (1 to 20) alkylene (C2 to C20) oxide adducts of aliphatic alcohol compounds (wherein specific examples of the alkylene oxide include ethylene oxide, propylene oxide, butylene oxide, pentylene oxide and hexylene oxide).

Examples of monofunctional monomers include (meth)acrylates of alkylene oxide adducts of 2 to 20 carbon atoms, such as methanol mono or poly (1 to 20) alkylene (C2 to C20) oxide adduct (meth)acrylate (wherein specific examples of the alkylene oxide include ethylene oxide, propylene oxide and butylene oxide), ethanol mono or poly (1 to 20) alkylene (C2 to C20) oxide adduct (meth)acrylate (wherein specific examples of the alkylene oxide include ethylene oxide, propylene oxide and butylene oxide), butanol mono or poly (1 to 20) alkylene (C2 to C20) oxide adduct (meth)acrylate (wherein specific examples of the alkylene oxide include ethylene oxide, propylene oxide and butylene oxide), hexanol mono or poly (1 to 20) alkylene (C2 to C20) oxide adduct (meth)acrylate (wherein specific examples of the alkylene oxide include ethylene oxide, propylene oxide and butylene oxide), octanol mono or poly (1 to 20) alkylene (C2 to C20) oxide adduct (meth)acrylate (wherein specific examples of the alkylene oxide include ethylene oxide, propylene oxide and butylene oxide), dodecanol mono or poly (1 to 20) alkylene (C2 to C20) oxide adduct (meth)acrylate (wherein specific examples of the alkylene oxide include ethylene oxide, propylene oxide and butylene oxide), and stearyl alcohol mono or poly (1 to 20) alkylene (C2 to C20) oxide adduct (meth)acrylate (wherein specific examples of the alkylene oxide include ethylene oxide and propylene oxide). Other examples include butylphenol, octylphenol, nonylphenol or dodecylphenol mono or poly (1 to 20) alkylene (C2 to C20) oxide adduct (meth)acrylate (wherein specific examples of the alkylene oxide include ethylene oxide, propylene oxide and butylene oxide).

Examples of difunctional monomers include ethylene glycol mono or poly (1 to 20) alkylene (C2 to C20) oxide adduct di(meth)acrylate (wherein specific examples of the alkylene oxide include ethylene oxide, propylene oxide and butylene oxide), diethylene glycol mono or poly (1 to 20) alkylene (C2 to C20) oxide adduct di(meth)acrylate (wherein specific examples of the alkylene oxide include ethylene oxide, propylene oxide and butylene oxide), diethylene glycol poly (2 to 20) alkylene (C2 to C20) oxide adduct di(meth)acrylate (wherein specific examples of the alkylene oxide include ethylene oxide, propylene oxide and butylene oxide), polyethylene glycol poly (2 to 20) alkylene (C2 to C20) oxide adduct di(meth)acrylate (wherein specific examples of the alkylene oxide include ethylene oxide, propylene oxide and butylene oxide), propylene glycol poly (2 to 20) alkylene (C2 to C20) oxide adduct di(meth)acrylate (wherein specific examples of the alkylene oxide include ethylene oxide, propylene oxide and butylene oxide), dipropylene glycol poly (2 to 20) alkylene (C2 to C20) oxide adduct di(meth)acrylate (wherein specific examples of the alkylene oxide include ethylene oxide, propylene oxide and butylene oxide), tripropylene glycol poly (2 to 20) alkylene (C2 to C20) oxide adduct di(meth)acrylate (wherein specific examples of the alkylene oxide include ethylene oxide, propylene oxide and butylene oxide), polypropylene glycol poly (2 to 20) alkylene (C2 to C20) oxide adduct di(meth)acrylate (wherein specific examples of the alkylene oxide include ethylene oxide, propylene oxide and butylene oxide), butylene glycol poly (2 to 20) alkylene (C2 to C20) oxide adduct di(meth)acrylate (wherein specific examples of the alkylene oxide include ethylene oxide, propylene oxide and butylene oxide), pentyl glycol poly (2 to 20) alkylene (C2 to C20) oxide adduct di(meth)acrylate (wherein specific examples of the alkylene oxide include ethylene oxide, propylene oxide and butylene oxide), neopentyl glycol poly (2 to 20) alkylene (C2 to C20) oxide adduct di(meth)acrylate (wherein specific examples of the alkylene oxide include ethylene oxide, propylene oxide and butylene oxide), hydroxypivalyl hydroxypivalate poly (2 to 20) alkylene (C2 to C20) oxide adduct di(meth)acrylate (wherein specific examples of the alkylene oxide include ethylene oxide, propylene oxide and butylene oxide), hydroxypivalyl hydroxypivalate dicaprolactonate poly (2 to 20) alkylene (C2 to C20) oxide adduct di(meth)acrylate (wherein specific examples of the alkylene oxide include ethylene oxide, propylene oxide and butylene oxide), 1,6-hexanediol poly (2 to 20) alkylene (C2 to C20) oxide adduct di(meth)acrylate (wherein specific examples of the alkylene oxide include ethylene oxide, propylene oxide and butylene oxide), 1,2-hexanediol poly (2 to 20) alkylene (C2 to C20) oxide adduct di(meth)acrylate (wherein specific examples of the alkylene oxide include ethylene oxide, propylene oxide and butylene oxide), 1,5-hexanediol poly (2 to 20) alkylene (C2 to C20) oxide adduct di(meth)acrylate (wherein specific examples of the alkylene oxide include ethylene oxide, propylene oxide and butylene oxide), 2,5-hexanediol poly (2 to 20) alkylene (C2 to C20) oxide adduct di(meth)acrylate (wherein specific examples of the alkylene oxide include ethylene oxide, propylene oxide and butylene oxide), 1,7-heptanediol poly (2 to 20) alkylene (C2 to C20) oxide adduct di(meth)acrylate (wherein specific examples of the alkylene oxide include ethylene oxide, propylene oxide and butylene oxide), 1,8-octanediol poly (2 to 20) alkylene (C2 to C20) oxide adduct di(meth)acrylate (wherein specific examples of the alkylene oxide include ethylene oxide, propylene oxide and butylene oxide), 1,2-octanediol poly (2 to 20) alkylene (C2 to C20) oxide adduct di(meth)acrylate (wherein specific examples of the alkylene oxide include ethylene oxide, propylene oxide and butylene oxide), 1,9-nonanediol poly (2 to 20) alkylene (C2 to C20) oxide adduct di(meth)acrylate (wherein specific examples of the alkylene oxide include ethylene oxide, propylene oxide and butylene oxide), 1,2-decanediol poly (2 to 20) alkylene (C2 to C20) oxide adduct di(meth)acrylate (wherein specific examples of the alkylene oxide include ethylene oxide, propylene oxide and butylene oxide), 1,10-decanediol poly (2 to 20) alkylene (C2 to C20) oxide adduct di(meth)acrylate (wherein specific examples of the alkylene oxide include ethylene oxide, propylene oxide and butylene oxide), 1,12-dodecanediol poly (2 to 20) alkylene (C2 to C20) oxide adduct di(meth)acrylate (wherein specific examples of the alkylene oxide include ethylene oxide, propylene oxide and butylene oxide), 1,2-dodecanediol mono or poly (1 to 20) alkylene (C2 to C20) oxide adduct di(meth)acrylate (wherein specific examples of the alkylene oxide include ethylene oxide, propylene oxide and butylene oxide), 1,14-tetradecanediol poly (2 to 20) alkylene (C2 to C20) oxide adduct di(meth)acrylate (wherein specific examples of the alkylene oxide include ethylene oxide, propylene oxide and butylene oxide), 1,2-tetradecanediol poly (2 to 20) alkylene (C2 to C20) oxide adduct di(meth)acrylate (wherein specific examples of the alkylene oxide include ethylene oxide, propylene oxide and butylene oxide), 1,16-hexadecanediol mono or poly (1 to 20) alkylene (C2 to C20) oxide adduct di(meth)acrylate (wherein specific examples of the alkylene oxide include ethylene oxide, propylene oxide and butylene oxide), 1,2-hexadecanediol poly (2 to 20) alkylene (C2 to C20) oxide adduct di(meth)acrylate (wherein specific examples of the alkylene oxide include ethylene oxide, propylene oxide and butylene oxide), 2-methyl-2,4-pentanediol poly (2 to 20) alkylene (C2 to C20) oxide adduct di(meth)acrylate (wherein specific examples of the alkylene oxide include ethylene oxide, propylene oxide and butylene oxide), 3-methyl-1,5-pentanediol poly (2 to 20) alkylene (C2 to C20) oxide adduct di(meth)acrylate (wherein specific examples of the alkylene oxide include ethylene oxide, propylene oxide and butylene oxide), 2-methyl-2-propyl-1,3-propanediol poly (2 to 20) alkylene (C2 to C20) oxide adduct di(meth)acrylate (wherein specific examples of the alkylene oxide include ethylene oxide, propylene oxide and butylene oxide), 2,4-dimethyl-2,4-pentanediol poly (2 to 20) alkylene (C2 to C20) oxide adduct di(meth)acrylate (wherein specific examples of the alkylene oxide include ethylene oxide, propylene oxide and butylene oxide), 2,2-diethyl-1,3-propanediol mono or poly (1 to 20) alkylene (C2 to C20) oxide adduct di(meth)acrylate (wherein specific examples of the alkylene oxide include ethylene oxide, propylene oxide and butylene oxide), 2,2,4-trimethyl-1,3-pentanediol mono or poly (1 to 20) alkylene (C2 to C20) oxide adduct di(meth)acrylate (wherein specific examples of the alkylene oxide include ethylene oxide, propylene oxide and butylene oxide), dimethyloloctane poly (2 to 20) alkylene (C2 to C20) oxide adduct di(meth)acrylate (wherein specific examples of the alkylene oxide include ethylene oxide, propylene oxide and butylene oxide), 2-ethyl-1,3-hexanediol poly (2 to 20) alkylene (C2 to C20) oxide adduct di(meth)acrylate (wherein specific examples of the alkylene oxide include ethylene oxide, propylene oxide and butylene oxide), 2,5-dimethyl-2,5-hexanediol poly (2 to 20) alkylene (C2 to C20) oxide adduct di(meth)acrylate (wherein specific examples of the alkylene oxide include ethylene oxide, propylene oxide and butylene oxide), 2-methyl-1,8-octanediol poly (2 to 20) alkylene (C2 to C20) oxide adduct di(meth)acrylate (wherein specific examples of the alkylene oxide include ethylene oxide, propylene oxide and butylene oxide), 2-butyl-2-ethyl-1,3-propanediol poly (2 to 20) alkylene (C2 to C20) oxide adduct di(meth)acrylate (wherein specific examples of the alkylene oxide include ethylene oxide, propylene oxide and butylene oxide), and 2,4-diethyl-1,5-pentanediol poly (2 to 20) alkylene (C2 to C20) oxide adduct di(meth)acrylate (wherein specific examples of the alkylene oxide include ethylene oxide, propylene oxide and butylene oxide).

Examples of trifunctional monomers include glycerol poly (2 to 20) alkylene (C2 to C20) oxide adduct tri(meth)acrylate (wherein specific examples of the alkylene oxide include ethylene oxide, propylene oxide and butylene oxide), trimethylolpropane poly (2 to 20) alkylene (C2 to C20) oxide adduct tri(meth)acrylate (wherein specific examples of the alkylene oxide include ethylene oxide, propylene oxide and butylene oxide), trimethylolethane poly (2 to 20) alkylene (C2 to C20) oxide adduct tri(meth)acrylate (wherein specific examples of the alkylene oxide include ethylene oxide, propylene oxide and butylene oxide), trimethylolhexane poly (2 to 20) alkylene (C2 to C20) oxide adduct tri(meth)acrylate (wherein specific examples of the alkylene oxide include ethylene oxide, propylene oxide and butylene oxide), trimethyloloctane poly (2 to 20) alkylene (C2 to C20) oxide adduct tri(meth)acrylate (wherein specific examples of the alkylene oxide include ethylene oxide, propylene oxide and butylene oxide), trimethyloloctane poly (3 to 20) alkylene (C2 to C20) oxide adduct tri(meth)acrylate (wherein specific examples of the alkylene oxide include ethylene oxide, propylene oxide and butylene oxide), and pentaerythritol poly (2 to 20) alkylene (C2 to C20) oxide adduct tri(meth)acrylate (wherein specific examples of the alkylene oxide include ethylene oxide, propylene oxide and butylene oxide).

Examples of tetrafunctional or higher functional monomers include pentaerythritol poly (2 to 20) alkylene (C2 to C20) oxide adduct tetra(meth)acrylate (wherein specific examples of the alkylene oxide include ethylene oxide, propylene oxide and butylene oxide), ditrimethylolpropane poly (2 to 20) alkylene (C2 to C20) oxide adduct tetra(meth)acrylate (wherein specific examples of the alkylene oxide include ethylene oxide, propylene oxide and butylene oxide), ditrimethylolpropane poly (2 to 20) alkylene (C2 to C20) oxide adduct tetra(meth)acrylate (wherein specific examples of the alkylene oxide include ethylene oxide, propylene oxide and butylene oxide), ditrimethylolpropane tetracaprolactonate poly (2 to 20) alkylene (C2 to C20) oxide adduct tetra(meth)acrylate (wherein specific examples of the alkylene oxide include ethylene oxide, propylene oxide and butylene oxide), ditrimethylolethane poly (2 to 20) alkylene (C2 to C20) oxide adduct tetra(meth)acrylate (wherein specific examples of the alkylene oxide include ethylene oxide, propylene oxide and butylene oxide), ditrimethylolpropane poly (2 to 20) alkylene (C2 to C20) oxide adduct tetra(meth)acrylate (wherein specific examples of the alkylene oxide include ethylene oxide, propylene oxide and butylene oxide), ditrimethylolbutane poly (2 to 20) alkylene (C2 to C20) oxide adduct tetra(meth)acrylate (wherein specific examples of the alkylene oxide include ethylene oxide, propylene oxide and butylene oxide), ditrimethylolhexane poly (2 to 20) alkylene (C2 to C20) oxide adduct tetra(meth)acrylate (wherein specific examples of the alkylene oxide include ethylene oxide, propylene oxide and butylene oxide), ditrimethylolhexane poly (2 to 20) alkylene (C2 to C20) oxide adduct tetra(meth)acrylate (wherein specific examples of the alkylene oxide include ethylene oxide, propylene oxide and butylene oxide), ditrimethyloloctane poly (2 to 20) alkylene (C2 to C20) oxide adduct tetra(meth)acrylate (wherein specific examples of the alkylene oxide include ethylene oxide, propylene oxide and butylene oxide), ditrimethyloloctane poly (4 to 200) alkylene (C2 to C20) oxide adduct tetra(meth)acrylate (wherein specific examples of the alkylene oxide include ethylene oxide, propylene oxide and butylene oxide), dipentaerythritol poly (5 to 20) alkylene (C2 to C20) oxide adduct penta(meth)acrylate (wherein specific examples of the alkylene oxide include ethylene oxide, propylene oxide and butylene oxide), dipentaerythritol poly (2 to 20) alkylene (C2 to C20) oxide adduct hexa(meth)acrylate (wherein specific examples of the alkylene oxide include ethylene oxide, propylene oxide and butylene oxide), dipentaerythritol hexacaprolactonate poly (2 to 20) alkylene (C2 to C20) oxide adduct hexa(meth)acrylate (wherein specific examples of the alkylene oxide include ethylene oxide, propylene oxide and butylene oxide), tripentaerythritol poly (2 to 20) alkylene (C2 to C20) oxide adduct hepta(meth)acrylate (wherein specific examples of the alkylene oxide include ethylene oxide, propylene oxide and butylene oxide), tripentaerythritol poly (2 to 20) alkylene (C2 to C20) oxide adduct octa(meth)acrylate (wherein specific examples of the alkylene oxide include ethylene oxide, propylene oxide and butylene oxide), tripentaerythritol poly (2 to 20) alkylene (C2 to C20) oxide adduct hexa(meth)acrylate (wherein specific examples of the alkylene oxide include ethylene oxide, propylene oxide and butylene oxide), tripentaerythritol poly (2 to 20) alkylene (C2 to C20) oxide adduct hepta(meth)acrylate (wherein specific examples of the alkylene oxide include ethylene oxide, propylene oxide and butylene oxide), and tripentaerythritol poly (2 to 20) alkylene (C2 to C20) oxide adduct octa(meth)acrylate (wherein specific examples of the alkylene oxide include ethylene oxide, propylene oxide and butylene oxide).

The “acrylate monomer having a molecular weight of 330 or less and containing 1 to 3 acryloyl groups”, the “compound having a (meth)acryloyl group” and the “compound having an ethylenic double bond” can each be selected appropriately from among the monomers having an ethylenic double bond listed above. For each compound, either a single monomer having an ethylenic double bond may be used alone, or a combination of two or more monomers may be used.

Examples of compounds that can be used favorably as the acrylate monomer having a molecular weight of 330 or less and containing 1 to 3 acryloyl groups include propylene oxide-modified neopentyl glycol diacrylate, 1,9-nonanediol diacrylate, trimethylolpropane triacrylate, tripropylene glycol diacrylate and neopentyl glycol hydroxypivalate diacrylate.

The propylene oxide-modified neopentyl glycol diacrylate can be represented, for example, by the formula shown below.

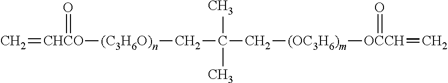

Propylene oxide-modified neopentyl glycol diacrylate

Each of m and n represents 0, 1 or 2, and 1≦m+n≦2.

In the present embodiment, the molecular weight of each monomer refers to the relative molecular mass calculated from the molecular formula.

The amount of the acrylate monomer having a molecular weight of 330 or less and containing 1 to 3 acryloyl groups is preferably within a range from 1 to 40% by weight, more preferably from 1 to 30% by weight, and still more preferably from 1 to 20% by weight, relative to the total weight of the active energy beam-curable ink. If the amount is less than 1% by weight, then the so-called anchoring effect weakens, and an improvement in adhesion may not be achievable. Further, if the monomer is included in an amount exceeding 40% by weight, then the curability may deteriorate in some cases.

Further, the amount of the monomer having an ethylenic double bond is preferably within a range from 3 to 65% by weight, more preferably from 10 to 50% by weight, and still more preferably from 20 to 40% by weight, relative to the total weight of the active energy beam-curable ink. If the amount is less than 3% by weight, then the adhesion may deteriorate, whereas if the amount exceeds 65% by weight, then there may be effects on the curability.

The α-aminoalkylphenone compounds (A1) and the acylphosphine oxide compounds (A2) used as the photopolymerization initiator are photocleavage initiators, and are preferably compounds having a molar absorption coefficient at a wavelength of 365 nm of 100 to 1,000,000 (l/mol·cm).

The molar absorption coefficient at a wavelength of 365 nm describes the value determined by dissolving the photopolymerization initiator in acetonitrile and then measuring the molar absorption coefficient at 365 nm (measurement apparatus: UV-3600 (manufactured by Shimadzu Corporation), measurement conditions: wavelength scan range from 200 to 800 nm, measurements performed using a slit width of 5 nm).

In the units (l/mol·cm) for the molar absorption coefficient, “l” represents “liter”, namely a unit of volume.

Examples of α-aminoalkylphenone compounds (A1) having a molar absorption coefficient at a wavelength of 365 nm of 100 to 1,000,000 (l/mol·cm) include one or more compounds selected from the group consisting of 2-benzyl-2-dimethylamino-1-(4-morpholin-4-yl-phenyl)-butan-1-one, 2-dimethylamino-2-(4-methylbenzyl)-1-(4-morpholin-4-yl-phenyl)-butan-1-one, and 2-methyl-1-[4-(methylthio)phenyl]-2-morpholinopropan-1-one. These α-aminoalkylphenone compounds (A1) may be used individually, or a combination of two or more compounds may be used.

Examples of acylphosphine oxide compounds (A2) having a molar absorption coefficient at a wavelength of 365 mu of 100 to 1,000,000 (l/mol·cm) include bis(2,4,6-trimethylbenzoyl)-phenylphosphine oxide, 2,4,6-trimethylbenzoyl-diphenylphosphine oxide, and bis(2,6-dimethoxybenzoyl)-2,4,4-trimethyl-pentylphosphine oxide. Among these compounds, 2,4,6-trimethylbenzoyl-diphenylphosphine oxide and/or bis(2,4,6-trimethylbenzoyl)-phenylphosphine oxide is desirable, particularly from the viewpoint of solubility of the compound within the overall ink. These acylphosphine oxide compounds (A2) may be used individually, or a combination of two or more compounds may be used.

The thioxanthone compounds (B1) and the benzophenone compounds (B2) used as the photopolymerization initiator are hydrogen abstraction polymerization initiators, and are preferably compounds having a molar absorption coefficient at a wavelength of 365 nm of 1,000 to 1,000,000 (l/mol·cm).

Examples of thioxanthone compounds (B1) having a molar absorption coefficient at a wavelength of 365 nm of 1,000 to 1,000,000 (l/mol·cm) include 2,4-diethylthioxanthone, 2,4-dimethylthioxanthone, 2,4-diisopropylthioxanthone, 2-isopropylthioxanthone, 4-diisopropylthioxanthone, 2-isopropylthioxanthone, 4-isopropylthioxanthone, 2,4-dichlorothioxanthone, 2-chlorothioxanthone, and 1-chloro-4-propoxythioxanthone, 2-hydroxy-3-(3,4-dimethyl-9-oxo-9H-thioxanthon-2-yloxy)-N,N,N-trimethyl-1-propanamine hydrochloride. The use of one or more compounds selected from the group consisting of 2,4-diethylthioxanthone, 2,4-dimethylthioxanthone, 2,4-dichlorothioxanthone, 1-chloro-4-propoxythioxanthone, 2-chlorothioxanthone and 2-isopropylthioxanthone is preferable. These thioxanthone compounds (A) may be used individually, or a combination of two or more compounds may be used.

Examples of benzophenone compounds (B2) having a molar absorption coefficient at a wavelength of 365 nm of 1,000 to 1,000,000 (l/mol·cm) include 4,4′-dialkylaminobenzophenones such as 4,4′-bis(dimethylamino)benzophenone and 4,4′-bis(diethylamino)benzophenone, as well as 4-benzoyl-4′-methyldiphenyl sulfide. Among these compounds, from the viewpoint of safety, 4,4′-bis(diethylamino)benzophenone and/or 4-benzoyl-4′-methyldiphenyl sulfide is preferable. These benzophenone compounds (B2) may be used individually, or a combination of two or more compounds may be used.

A tertiary amine compound may be included in the active energy beam-curable ink. The tertiary amine compound is a compound exclusive of the α-aminoalkylphenone compound (A1), the acylphosphine oxide compound (A2), the thioxanthone compound (B1) and the benzophenone compound (B2), and specific examples include N,N-dimethylaniline, N,N-diethylaniline, N,N-dimethyl-p-toluidine, ethyl 4-(dimethylamino)benzoate, N,N-dihydroxyethylaniline, triethylamine, and N,N-dimethylhexylamine. These tertiary amine compound may be used individually, or a combination of two or more compounds may be used.

Among the above compounds, aromatic tertiary amines in which an aromatic group is bonded directly to the nitrogen atom N are preferable, and ethyl 4-(dimethylamino)benzoate and isoamyl 4-(dimethylamino)benzoate are particularly preferable.

As described above, in the present embodiment, the photopolymerization initiator is preferably a combination of a photocleavage photopolymerization initiator composed of the α-aminoalkylphenone compound (A1) having a molar absorption coefficient at a wavelength of 365 nm of 100 to 1,000,000 (l/mol·cm) and/or the acylphosphine oxide compound (A2) having a molar absorption coefficient at a wavelength of 365 nm of 100 to 1,000,000 (l/mol·cm), and a hydrogen abstraction photopolymerization initiator composed of the thioxanthone compound (B1) having a molar absorption coefficient at a wavelength of 365 nm of 1,000 to 1,000,000 (l/mol·cm) and/or the benzophenone compound (B2) having a molar absorption coefficient at a wavelength of 365 nm of 1,000 to 1,000,000 (l/mol·cm), and may also include, where necessary, a tertiary amine compound. Provided that the photopolymerization initiator comprises three or more types of compounds selected from these α-aminoalkylphenone compounds (A1), acylphosphine oxide compounds (A2), thioxanthone compounds (B1), and benzophenone compounds (B2), then an active energy beam-curable ink having excellent curing characteristics and excellent printing characteristics can be obtained, even in those cases where a light source that emits ultraviolet light of 200 to 420 nm, such as a metal halide lamp, high-pressure mercury lamp or electrodeless metal halide lamp fitted with an ozone cut filter or infrared filter, or a UV-LED (wavelength: 350 to 385 nm) is used as the ultraviolet light source.

The active energy beam-curable ink may also contain components besides the acrylate monomer having a molecular weight of 330 or less and containing 1 to 3 acryloyl groups, (A1), (A2), (B1), (B2) and the tertiary amine compound. There are no particular limitations on these other components, and any components typically added to radical polymerizable ink compositions may be used, provided they do not impair the effects of the present embodiment. Examples of these other components include other photopolymerization initiators, pigments, resins, other compounds having an ethylenic double bond such as (meth)acryloyl group-containing compounds, and additives.

Examples of initiators that can be used besides the compounds mentioned above as examples of (A1), (A2), (B1), (B2) and the tertiary amine compound include benzophenone, 4-methylbenzophenone, 2,4,6-trimethylbenzophenone, 2,3,4-trimethylbenzophenone, 4-phenylbenzophenone, 3,3′-dimethyl-4-methoxybenzophenone, 4-(1,3-acryloyl-1,4,7,10,13-pentaoxotridecyl)benzophenone, methyl o-benzoylbenzoate, [4-(methylphenylthio)phenyl]phenylmethanone, (4-benzoylbenzyl)trimethylammonium chloride, 2-hydroxy-2-methyl-1-phenylpropan-1-one, 1 -(4-isopropylphenyl)-2-hydroxy-2-methyl-1-phenylpropan-1-one, 1-hydroxycyclohexyl phenyl ketone, polymer of 2-hydroxy-2-methyl-1-styrylpropan-1-one, diethoxyacetophenone, dibutoxyacetophenone, benzoin methyl ether, benzoin ethyl ether, benzoin isopropyl ether, benzoin isobutyl ether, and benzoin normal butyl ether. These compounds may be used individually or in combinations.

Examples of the resins include both thermosetting resins and thermoplastic resins, and specific examples include polyvinyl chloride, poly(meth)acrylates, epoxy resins, polyurethane resins, cellulose derivatives (such as ethyl cellulose, cellulose acetate and nitrocellulose), vinyl chloride/vinyl acetate copolymers, polyamide resins, polyvinyl acetal resins, diallyl phthalate resins, and synthetic rubbers such as butadiene/acrylonitrile copolymers. These resins may be used individually or in combinations of two or more resins. Moreover, examples of resins that can be used in hybrid inks that combine the characteristics of an oil-based ink and an active energy beam-curable ink include rosin phenolic resins, rosin alkyd resins, petroleum resin-modified alkyd resins, and styrene/acrylate resins (such as styrene/isobornyl acrylate resins). Animal or plant-based oils or fatty acid monoesters thereof may also be used.

Examples of the pigments include both inorganic pigments and organic pigments. Examples of inorganic pigments that can be used include chrome yellow, zinc chrome, iron blue, barium sulfate, cadmium red, titanium oxide, zinc oxide, red iron oxide, alumina white, calcium carbonate, ultramarine, carbon black, graphite, aluminum powder and red iron oxide. Examples of organic pigments that can be used include various well-known and commonly used pigments, including soluble azo pigments such as β-naphthol-based pigments, β-oxynaphthoic acid-based pigments, β-oxynaphthoic acid anilide-based pigments, acetoacetic acid anilide-based pigments and pyrazolone-based pigments; insoluble azo pigments such as β-naphthol-based pigments, β-oxynaphthoic acid anilide-based pigments, acetoacetic acid anilide-based monoazo pigments, acetoacetic acid anilide-based disazo pigments and pyrazolone-based pigments; phthalocyanine pigments such as copper phthalocyanine blue, halogenated (chlorinated or brominated) copper phthalocyanine blue, sulfonated copper phthalocyanine blue and metal free phthalocyanine; and polycyclic pigments and heterocyclic pigments such as quinacridone-based pigments, dioxazine-based pigments, threne-based pigments (such as pyranthrone, anthanthrone, indanthrone, anthrapyrimidine, flavanthrone, thioindigo-based pigments, anthraquinone-based pigments, perinone-based pigments and perylene-based pigments), isoindolinone-based pigments, metal complex-based pigments and quinophthalone-based pigments.

If required, other additives may also be used in the active energy beam-curable ink.

For example, specific examples of additives that may be used for imparting rub resistance, anti-blocking characteristics, slipperiness and scratch resistance include natural waxes such as carnauba wax, Japan wax, lanolin, montan wax, paraffin wax and microcrystalline wax, and synthetic waxes such as Fischer-Tropsch wax, polyethylene wax, polypropylene wax, polytetrafluoroethylene wax, polyamide wax and silicone compounds.

Examples of additives for imparting storage stability to the ink include polymerization inhibitors such as (alkyl)phenols, hydroquinone, catechol, resorcin, p-methoxyphenol, t-butylcatechol, t-butylhydroquinone, pyrogallol, 1,1-picrylhydrazyl, phenothiazine, p-benzoquinone, nitrosobenzene, 2,5-di-tert-butyl-p-benzoquinone, dithiobenzoyl disulfide, picric acid, cupferron, aluminum N-nitrosophenylhydroxylamine, tri-p-nitrophenylmethyl, N-(3-oxyanilino-1,3-dimethylbutylidene)aniline oxide, dibutylcresol, cyclohexanone oxime cresol, guaiacol, o-isopropylphenol, butyraldoxime, methyl ethyl ketoxime, and cyclohexanone oxime.

In addition, depending on the performance required, other additives such as ultraviolet absorbers, infrared absorbers and antibacterial agents may also be added.

The active energy beam-curable ink of the present embodiment is often used as a lithographic printing ink. When used as a lithographic printing ink, the ink is preferably used with a composition comprising 10 to 30% by weight of the pigment, 20 to 50% by weight of the resin, 3 to 65% by weight of the monomer having an ethylenic double bond, 0.01 to 1% by weight of the radical polymerization inhibitor, 0.5 to 20% by weight of the photopolymerization initiator, and 0 to 10% by weight of other additives. Further, when an acrylic resin is used as the resin, because acrylic resins are solid at normal temperatures, the resin is used in the form of a resin varnish prepared by dissolving the resin in an acrylic monomer or oligomer, and then adding the radical polymerization inhibitor. In order to adjust the viscosity of the resin varnish to a viscosity that facilitates preparation of the printing ink composition (namely, a viscosity of 100 to 300 Pa·s/25° C.), the varnish is prepared by combining 20 to 50% by weight of the resin, 80 to 50% by weight of the acrylic monomer or oligomer, and 0.01 to 1% by weight of the radical polymerization inhibitor, and then heating at a temperature of 80 to 120° C. under a stream of air for 30 minutes to one hour to dissolve the resin.

The proportions of the photocleavage photopolymerization initiator having a molar absorption coefficient at a wavelength of 365 nm of 100 to 1,000,000 (l/mol·cm), the hydrogen abstraction photopolymerization initiator having a molar absorption coefficient at a wavelength of 365 nm of 1,000 to 1,000,000 (l/mol·cm), the tertiary amine compound, and the resin, the pigment, and the compounds containing acylate groups may be set as appropriate depending on the performance required. Generally, the initiators, namely the photocleavage photopolymerization initiator having a molar absorption coefficient at a wavelength of 365 nm of 100 to 1,000,000 (l/mol·cm) and the hydrogen abstraction photopolymerization initiator having a molar absorption coefficient at a wavelength of 365 nm of 1,000 to 1,000,000 (l/mol·cm), exhibit superior reactivity upon irradiation with light in the vicinity of 365 nm, thereby improving the curability of the ink, but if excessive amounts of these initiators are used, then the intensity of the active energy beam may decrease in the depth direction, which can sometimes cause a deterioration in the internal curability of the ink. Further, if excessive amounts of the initiators are used, then residual unreacted components can function as plasticizers, which can cause a deterioration in the strength of the ink cured product.

Accordingly, an example of a preferred composition for the active energy beam-curable ink is shown below, with the amount of each component shown relative to the total weight of the ink. However, the ink composition is not limited to the ranges shown below.

(1) Photocleavage polymerization initiator having a molar absorption coefficient at a wavelength of 365 nm of 100 to 1,000,000 (l/mol·cm) (the combined weight of the α-aminoalkylphenone compound (A1) and the acylphosphine oxide compound (A2)): 1 to 20% by weight

(2) Hydrogen abstraction polymerization initiator having a molar absorption coefficient at a wavelength of 365 nm of 1,000 to 1,000,000 (l/mol·cm) (the combined weight of the thioxanthone compound (B1) and the benzophenone compound (B2)): 1 to 10% by weight

(3) Tertiary amine compound (excluding the a-aminoalkylphenone compound (A1) and the benzophenone compound (B2)): 0 to 10% by weight

(4) Monomer having an ethylenic double bond: 3 to 65% by weight

(5) Resin: 0 to 30% by weight (and preferably 5 to 30% by weight)

(6) Pigment: 0 to 30% by weight (and preferably 10 to 30% by weight)

(7) Other additives: 0 to 10% by weight

Production of the active energy beam-curable ink may be performed using the same types of methods as those used for producing conventional ultraviolet-curable inks. For example, the ink can be produced by kneading and mixing the ink composition components, including the pigment, the resin, the monomer having an ethylenic double bond, the polymerization inhibitor, sensitizers such as the initiators and the amine compound, and any other additives, at a temperature within a range from normal temperature to 100° C. using a kneading and mixing device such as a kneader, three roll mill, attritor, sand mill or gate mixer.

Specific examples of the active energy beam-curable ink used in the present embodiment include transparent overprint varnishes (commonly known as OP varnish) that are printed with a printer following monochrome or multicolor printing, and color printing inks such as a yellow, magenta, cyan and black inks.

According to the present embodiment, a method of producing an ink cured product can be provided that exhibits excellent curing characteristics for curing with an active energy beam, and particularly for curing using a light source that emits ultraviolet light of 200 to 420 nm by using a metal halide lamp, high-pressure mercury lamp or electrodeless metal halide lamp or the like that has been fitted with an ozone cut filter or infrared filter, and curing by ultraviolet irradiation using a light emitting diode (UV-LED) that emits ultraviolet light within a range from 350 to 420 nm. Further, the ink cured product can be obtained using any of various conventional printing systems, using offset inks, relief printing inks, intaglio printing inks, or stencil printing inks or the like. Further, when the production method of the present embodiment is applied to any of these printing systems, not only is excellent printability achieved, but an ink cured product is obtained that exhibits excellent storage stability, and good adhesion even to plastic films and papers having a high degree of smoothness.

Furthermore, another embodiment of the present invention relates to an ink cured product produced or molded on a substrate using the production method described above. Moreover, yet another embodiment of the present invention relates to a printed item having a substrate and the ink cured product mentioned above. When an active energy beam-curable ink is printed (formed) on a substrate using a printer, the combination of the substrate and the ink cured product provided on the substrate is generally referred to as a printed item. The printer may be any printer that is appropriate for the intended purpose of the embodiment, and specific examples include an offset printer and a gravure printer. The substrate is as described above, and includes plastic films and papers having a high degree of smoothness.

### EXAMPLES

The present invention is described below in further detail using a series of examples. In these examples, unless specifically stated otherwise, “parts” refers to “parts by weight”, and “%” refers to “% by weight”.

Using the compositions (parts) shown in Table 1, ink compositions of Examples 1 to 34 and Comparative Examples 1 to 3 were kneaded using a three roll mill to obtain a series of active energy beam-curable inks. Each of the obtained active energy beam-curable inks was printed at 0.2 cc/1,000 cm² onto the paper described below using an RI tester.

An RI tester is a test machine for printing an ink onto a paper or film, and can control the amount of ink transferred and the printing pressure.

OK Top Coat was used as the substrate, as an example of a paper having a high degree of smoothness. The degree of smoothness of the substrate was measured in the manner described below.

The paper was secured to a mount having an angle of inclination of 50°, and a single drop of 1,9-nonanediol diacrylate was dripped onto the paper from a 50 ml burette. Thirty seconds after dripping, the distance that the drop of 1,9-nonanediol diacrylate had flowed was measured. Measurement was performed at room temperature (25° C.), and the height of the outlet of the burette used for dripping the 1,9-nonanediol diacrylate was set at 10 cm above the paper.

Paper having a high degree of smoothness: OK Top Coat (57.5 kg/Al, manufactured by Oji Paper Co., Ltd.), average flow distance over 10 tests: 11.8 cm.

### <Evaluation of Surface Curability>

Using a high-output UV-LED irradiation device manufactured by Panasonic Corporation, ultraviolet light having a wavelength of 350 to 420 nm (central wavelength: 385 nm) was irradiated onto the printed surface from an irradiation distance of 10 mm while the conveyor speed (m/min) was varied, the printed surface was then touched with a finger to confirm whether or not the surface was tacky. The fastest conveyor speed at which no surface tack was observed was recorded as the “surface curability”, and this value was then evaluated against the following evaluation criteria. A faster conveyor speed, and therefore a smaller irradiation dose, was deemed to indicate superior surface curability. An evaluation of AB indicates that when multiple tests were performed, some results were A and some were B. An evaluation of BC is defined in a similar manner.

### (Evaluation Criteria)

A: 20 m/min or faster

B: at least 10 m/min, but less than 20 m/min

C: less than 10 m/min

Practically applicable levels are A, AB and B.

### <Evaluation of Adhesion>

Using the same high-output UV-LED irradiation device manufactured by Panasonic Corporation as that used for the surface curability evaluation, ultraviolet light having a wavelength of 350 to 420 nm (central wavelength: 385 nm) was irradiated onto the printed surface from an irradiation distance of 10 mm at a conveyor speed of 20 m/min, and 10 minutes after the irradiation, a cellophane tape was stuck to the printed surface and then peeled away by hand, and the degree of peeling of the ink cured product was observed. The adhesion was evaluated against the following evaluation criteria.

### (Evaluation Criteria)

A: no peeling

AB: slight peeling

B: approximately half of the cured product peeled

BC: at least half of the cured product peeled

C: almost all of the cured product peeled

Practically applicable levels are A and AB.

TABLE 1

| | | | Example | | | | | | | | | | | | |
|---|---|---|---|---|---|---|---|---|---|---|---|---|---|---|---|
| | | | 1 | 2 | 3 | 4 | 5 | 6 | 7 | 8 | 9 | 10 | 11 | 12 | 13 |
| Raw | Resin | Diallyl phthalatc resin | 14 | 14 | 16 | 11 | 11 | 11 | 16 | 16 | 18 | 13 | 13 | 16 | 16 |
| materials | Acrylate monomers | Dipentaerythritol hexaacrylate | 38 | 38 | 19 | 42 | 42 | 42 | 38 | 38 | 19 | 42 | 42 | 38 | 38 |
| | other than the acrylate | Trimethylolpropane ethylene oxide | 0 | 10 | 0 | 14 | 14 | 14 | 0 | 10 | 0 | 14 | 14 | 0 | 10 |
| | monomer having a | adduct triacrylate | | | | | | | | | | | | | |
| | molecular weight of | | | | | | | | | | | | | | |
| | 330 or less and | | | | | | | | | | | | | | |
| | containing 1 to 3 | | | | | | | | | | | | | | |
| | acryloyl groups | | | | | | | | | | | | | | |
| | Acrylate monomer | Propylene oxide-modified neopentyl | 18 | | | | | | 18 | | | | | 18 | |
| | having a molecular | glycol diacrylate | | | | | | | | | | | | | |
| | weight of 330 or | 1,9-nonanediol diacrylate | | 8 | | | | | | 8 | | | | | 8 |
| | less and containing | Trimethylol propane triacrylate | | | 35 | | | | | | 35 | | | | |
| | 1 to 3 acryloyl | Tripropylene glycol diacrylate | | | | 3 | | | | | | 3 | | | |
| | groups | Neopentyl glycol hydroxypivalate | | | | | 3 | 3 | | | | | 3 | | |
| | | diacrylate | | | | | | | | | | | | | |
| | Pigment | C.I. Pigment Blue 15-4 | 20 | 20 | 20 | 20 | 20 | 20 | 20 | 20 | 20 | 20 | 20 | 20 | 20 |
| | Initiator (A1) | 2-dimethylamino-2-(4-methylbenzyl)- | 3 | 3 | 3 | | | | 3 | 3 | | | | | |
| | | 1-(4-morpholin-4-yl-phenyl)-butan-1- | | | | | | | | | | | | | |
| | | one | | | | | | | | | | | | | |
| | | 2-benzyl-2-dimethylamino-1-(4- | | | | 3 | | | | | 3 | 3 | | | |
| | | morpholinophenyl)-butanone-1 | | | | | | | | | | | | | |
| | | 2-methyl-1-[4-(methylthio)phenyl]-2- | | | | | 3 | 3 | | | | | 3 | | |
| | | morpholinopropan-1-one | | | | | | | | | | | | | |
| | Initiator (A2) | 2,4,6 -trimethylbenzoyl- | 3 | 3 | | | | | 3 | 3 | | | | 3 | 3 |
| | | diphenylphosphine oxide | | | | | | | | | | | | | |
| | | bis(2,4,6-trimethylbenzoyl)- | | | 3 | 3 | 3 | 3 | | | 3 | 3 | 3 | | |
| | | phenylphosphine oxide | | | | | | | | | | | | | |
| | Initiator (B1) | 2,4-diethylthioxanthone | 2 | | | | | | | | | | | 2 | |
| | | 2,4-dimethylthioxanthone | | 2 | | | | | | | | | | | 2 |
| | | 2,4-dichlorothioxanthone | | | 2 | | | | | | | | | | |
| | | 1-chloro-4-propylthioxanthone | | | | 2 | | | | | | | | | |
| | | 2-chlorothioxanthone | | | | | 2 | | | | | | | | |
| | | 2-isopropylthioxanthone | | | | | | 2 | | | | | | | |
| | Initiator (B2) | 4,4′-bis(diethylamino)benzophenone | 2 | 2 | 2 | 2 | 2 | 2 | 2 | 2 | 2 | 2 | 2 | 3 | 3 |
| | Tertiary amine | Ethyl 4-dimethylaminobenzoate | | | | | | | | | | | | | |
| | compound (C) | | | | | | | | | | | | | | |

| | | | | | | | | | | | | | |
|---|---|---|---|---|---|---|---|---|---|---|---|---|---|
| Total | 100 | 100 | 100 | 100 | 100 | 100 | 100 | 100 | 100 | 100 | 100 | 100 | 100 |

| | | | | | | | | | | | | | | | |
|---|---|---|---|---|---|---|---|---|---|---|---|---|---|---|---|
| Property | Adhesion | OK Top Coat (11.8 cm) | A | A | AB | A | A | A | AB | AB | AB | AB | AB | AB | AB |
| evaluations | Surface | OK Top Coat (11.8 cm) | AB | AB | AB | AB | AB | AB | B | B | B | B | B | B | B |
| | curability | | | | | | | | | | | | | | |

| | | | Example | | | | | | | | | | | | |
|---|---|---|---|---|---|---|---|---|---|---|---|---|---|---|---|
| | | | 14 | 15 | 16 | 17 | 18 | 19 | 20 | 21 | 22 | 23 | 24 | 25 | 26 |
| Raw | Resin | Diallyl phthalatc resin | 18 | 13 | 13 | 13 | 14 | 14 | 16 | 11 | 11 | 11 | 14 | 14 | 16 |
| materials | Acrylate monomers | Dipentaerythritol hexaacrylate | 19 | 42 | 42 | 42 | 36 | 36 | 19 | 40 | 40 | 40 | 38 | 38 | 19 |
| | other than the acrylate | Trimethylolpropane ethylene oxide | 0 | 14 | 14 | 14 | 0 | 10 | 0 | 14 | 14 | 14 | 0 | 10 | 0 |
| | monomer having a | adduct triacrylate | | | | | | | | | | | | | |
| | molecular weight of | | | | | | | | | | | | | | |
| | 330 or less and | | | | | | | | | | | | | | |
| | containing 1 to 3 | | | | | | | | | | | | | | |
| | acryloyl groups | | | | | | | | | | | | | | |
| | Acrylate monomer | Propylene oxide-modified neopentyl | | | | | 18 | | | | | | 18 | | |
| | having a molecular | glycol diacrylate | | | | | | | | | | | | | |
| | weight of 330 or | 1,9-nonanediol diacrylate | | | | | | 8 | | | | | | 8 | |
| | less and containing | Trimethylol propane triacrylate | 35 | | | | | | 33 | | | | | | 35 |
| | 1 to 3 acryloyl | Tripropylene glycol diacrylate | | 3 | | | | | | 3 | | | | | |
| | groups | Neopentyl glycol hydroxypivalate | | | 3 | 3 | | | | | 3 | 3 | | | |
| | | diacrylate | | | | | | | | | | | | | |
| | Pigment | C.I. Pigment Blue 15-4 | 20 | 20 | 20 | 20 | 20 | 20 | 20 | 20 | 20 | 20 | 20 | 20 | 20 |
| | Initiator (A1) | 2-dimethylamino-2-(4-methylbenzyl)- | | | | | 3 | 3 | 3 | | | | 3 | 3 | |
| | | 1-(4-morpholin-4-yl-phenyl)-butan-1- | | | | | | | | | | | | | |
| | | one | | | | | | | | | | | | | |
| | | 2-benzyl-2-dimethylamino-1-(4- | | | | | | | | 3 | | | | | 3 |
| | | morpholinophenyl)-butanone-1 | | | | | | | | | | | | | |
| | | 2-methyl-1-[4-(methylthio)phenyl]-2- | | | | | | | | | 3 | 3 | | | |
| | | morpholinopropan-1-one | | | | | | | | | | | | | |
| | Initiator (A2) | 2,4,6 -trimethylbenzoyl- | | | | | 3 | 3 | | | | | 3 | 3 | 3 |
| | | diphenylphosphine oxide | | | | | | | | | | | | | |
| | | bis(2,4,6-trimethylbenzoyl)- | 3 | 3 | 3 | 3 | | | 3 | 3 | 3 | 3 | | | |
| | | phenylphosphine oxide | | | | | | | | | | | | | |
| | Initiator (B1) | 2,4-diethylthioxanthone | | | | | 2 | | | | | | | | |
| | | 2,4-dimethylthioxanthone | | | | | | 2 | | | | | | | |
| | | 2,4-dichlorothioxanthone | 2 | | | | | | 2 | | | | | | |
| | | 1-chloro-4-propylthioxanthone | | 2 | | | | | | 2 | | | | | |
| | | 2-chlorothioxanthone | | | 2 | | | | | | 2 | | | | |
| | | 2-isopropylthioxanthone | | | | 2 | | | | | | 2 | | | |
| | Initiator (B2) | 4,4′-bis(diethylamino)benzophenone | 3 | 3 | 3 | 3 | 2 | 2 | 2 | 2 | 2 | 2 | 2 | 2 | 2 |
| | Tertiary amine | Ethyl 4-dimethylaminobenzoate | | | | | 2 | 2 | 2 | 2 | 2 | 2 | 2 | 2 | 2 |
| | compound (C) | | | | | | | | | | | | | | |

| | | | | | | | | | | | | | |
|---|---|---|---|---|---|---|---|---|---|---|---|---|---|
| Total | 100 | 100 | 100 | 100 | 100 | 100 | 100 | 100 | 100 | 100 | 100 | 100 | 100 |

| | | | | | | | | | | | | | | | |
|---|---|---|---|---|---|---|---|---|---|---|---|---|---|---|---|
| Property | Adhesion | OK Top Coat (11.8 cm) | AB | AB | AB | AB | A | A | A | A | A | A | A | A | A |
| evaluations | Surface | OK Top Coat (11.8 cm) | B | B | B | B | A | A | A | A | A | A | AB | AB | AB |
| | curability | | | | | | | | | | | | | | |

| | | | | | | | | Comparative | | |
|---|---|---|---|---|---|---|---|---|---|---|
| Example | | | | | | | | Example | | |
| 27 | 28 | 29 | 30 | 31 | 32 | 33 | 34 | 1 | 2 | 3 |

| | | | | | | | | | | | | | |
|---|---|---|---|---|---|---|---|---|---|---|---|---|---|
| Raw | Resin | Diallyl phthalatc resin | 11 | 11 | 14 | 14 | 16 | 11 | 11 | 11 | 11 | 11 | 5 |
| materials | Acrylate monomers | Dipentaerythritol hexaacrylate | 42 | 42 | 38 | 38 | 19 | 42 | 42 | 42 | 38 | 38 | 15 |
| | other than the acrylate | Trimethylolpropane ethylene oxide | 14 | 14 | 0 | 10 | 0 | 14 | 14 | 14 | 21 | 21 | 0 |
| | monomer having a | adduct triacrylate | | | | | | | | | | | |
| | molecular weight of | | | | | | | | | | | | |
| | 330 or less and | | | | | | | | | | | | |
| | containing 1 to 3 | | | | | | | | | | | | |
| | acryloyl groups | | | | | | | | | | | | |
| | Acrylate monomer | Propylene oxide-modified neopentyl | | | 18 | | | | | | | | |
| | having a molecular | glycol diacrylate | | | | | | | | | | | |
| | weight of 330 or | 1,9-nonanediol diacrylate | | | | 8 | | | | | | | 55 |
| | less and containing | Trimethylol propane triacrylate | | | | | 35 | | | | | | |
| | 1 to 3 acryloyl | Tripropylene glycol diacrylate | 3 | | | | | 3 | | | | | |
| | groups | Neopentyl glycol hydroxypivalate | | 3 | | | | | 3 | 3 | | | |
| | | diacrylate | | | | | | | | | | | |
| | Pigment | C.I. Pigment Blue 15-4 | 20 | 20 | 20 | 20 | 20 | 20 | 20 | 20 | 20 | 20 | 15 |
| | Initiator (A1) | 2-dimethylamino-2-(4-methylbenzyl)- | | | | | | | | | 3 | 3 | 10 |
| | | 1-(4-morpholin-4-yl-phenyl)-butan-1- | | | | | | | | | | | |
| | | one | | | | | | | | | | | |
| | | 2-benzyl-2-dimethylamino-1-(4- | 3 | | | | | | | | | | |
| | | morpholinophenyl)-butanone-1 | | | | | | | | | | | |
| | | 2-methyl-1-[4-(methylthio)phenyl]-2- | | 3 | | | | | | | | | |
| | | morpholinopropan-1-one | | | | | | | | | | | |
| | Initiator (A2) | 2,4,6 -trimethylbenzoyl- | 3 | 3 | 3 | 3 | 3 | 3 | 3 | 3 | 3 | 3 | |
| | | diphenylphosphine oxide | | | | | | | | | | | |
| | | bis(2,4,6-trimethylbenzoyl)- | | | | | | | | | 2 | | |
| | | phenylphosphine oxide | | | | | | | | | | | |
| | Initiator (B1) | 2,4-diethylthioxanthone | | | 2 | | | | | | | | |
| | | 2,4-dimethylthioxanthone | | | | 2 | | | | | | | |
| | | 2,4-dichlorothioxanthone | | | | | 2 | | | | | | |
| | | 1-chloro-4-propylthioxanthone | | | | | | 2 | | | | | |
| | | 2-chlorothioxanthone | | | | | | | 2 | | | | |
| | | 2-isopropylthioxanthone | | | | | | | | 2 | | | |
| | Initiator (B2) | 4,4′-bis(diethylamino)benzophenone | 2 | 2 | 3 | 3 | 3 | 3 | 3 | 3 | 2 | 2 | |
| | Tertiary amine | Ethyl 4-dimethylaminobenzoate | 2 | 2 | 2 | 2 | 2 | 2 | 2 | 2 | | | |
| | compound (C) | | | | | | | | | | | | |

| | | | | | | | | | | | |
|---|---|---|---|---|---|---|---|---|---|---|---|
| Total | 100 | 100 | 100 | 100 | 100 | 100 | 100 | 100 | 100 | 98 | 100 |

| | | | | | | | | | | | | | |
|---|---|---|---|---|---|---|---|---|---|---|---|---|---|
| Property | Adhesion | OK Top Coat (11.8 cm) | A | A | A | A | A | A | A | A | A | A | C |
| evaluations | Surface | OK Top Coat (11.8 cm) | AB | AB | AB | AB | AB | AB | AB | AB | BC | BC | B |
| | curability | | | | | | | | | | | | |

From the results in Table 1, it was evident that according to the embodiment described above, an ink cured product could be obtained which exhibited excellent photopolymerizability (surface curability) upon irradiation with ultraviolet light from a light emitting diode that emits ultraviolet light having an emission peak wavelength within a range from 350 to 420 nm, and also exhibited good adhesion to paper having a high degree of smoothness.

Further, in the examples, a high-output UV-LED irradiation device manufactured by Panasonic Corporation was used as the curing device, but substantially the same results were obtained when the evaluations were repeated using a metal halide lamp irradiation device manufactured by Eyegraphics Co., Ltd.

Further, substantially the same results were obtained when a synthetic paper having a high degree of smoothness or a polyethylene terephthalate film was used as the substrate.

1. A method of producing an ink cured product comprising a step of printing an active energy beam-curable ink comprising a monomer having an ethylenic double bond and a photopolymerization initiator onto a substrate, and curing the active energy beam-curable ink with an active energy beam, wherein
the monomer having an ethylenic double bond comprises an acrylate monomer having a molecular weight of 330 or less and containing 1 to 3 acryloyl groups,
the photopolymerization initiator comprises three or more types of compounds selected from the group consisting of:
(A1) α-aminoalkylphenone compounds,
(A2) acylphosphine oxide compounds,
(B1) thioxanthone compounds, and
(B2) benzophenone compounds, and
the substrate is either:
a paper having a property such that when the paper is secured to a mount having an angle of inclination of 50° and a single drop of 1,9-nonanediol diacrylate is dripped onto the paper from a 50 ml burette, the 1,9-nonanediol diacrylate flows at least 10 cm in 30 seconds, or
a plastic film.

2. The method of producing an ink cured product according to claim 1, wherein the substrate is a paper having a property such that when the paper is secured to a mount having an angle of inclination of 50° and a single drop of 1,9-nonanediol diacrylate is dripped onto the paper from a 50 ml burette, the 1,9-nonanediol diacrylate lows at least 10 cm in 30 seconds.

3. The method of producing an ink cured product according to claim 1, wherein the monomer having an ethylenic double bond is at least one compound selected from the group consisting of propylene oxide-modified neopentyl glycol diacrylate, 1,9-nonanediol diacrylate, trimethylolpropane triacrylate, tripropylene glycol diacrylate and neopentyl glycol hydroxypivalate diacrylate.

4. The method of producing an ink cured product according to claim 1, wherein an amount of the monomer having an ethylenic double bond is within a range from 3% by weight to 65% by weight, relative to a total weight of the active energy beam-curable ink.

5. The method of producing an ink cured product according to claim 1, wherein the α-aminoalkylphenone compound (A1) is at least one compound selected from the group consisting of 2-benzyl-2-dimethylamino-1-(4-morpholin-4-yl-phenyl)-butan-1-one, 2-dimethylamino-2-(4-methylbenzyl)-1-(4-morpholin-4-yl-phenyl)-butan-1-one, and 2-methyl-1-[4-(methylthio)phenyl]-2-morpholinopropan-1-one.

6. The method of producing an ink cured product according to claim 1, wherein the acylphosphine oxide compound (A2) is 2,4,6-trimethylbenzoyl-diphenylphosphine oxide and/or bis(2,4,6-trimethylbenzoyl)-phenylphosphine oxide.

7. The method of producing an ink cured product according to claim 1, wherein the thioxanthone compound (B1) is at least one compound selected from the group consisting of 2,4-diethylthioxanthone, 2,4-dimethylthioxanthone, 2,4-dichlorothioxanthone, 1-chloro-4-propylthioxanthone, 2-chlorothioxanthone and 2-isopropylthioxanthone.

8. The method of producing an ink cured product according to claim 1, wherein the benzophenone compound (B2) is 4,4′-bis(diethylamino)benzophenone and/or 4-benzoyl-4′-methyldiphenyl sulfide.

9. The method of producing an ink cured product according to claim 1, wherein the active energy beam-curable ink also comprises a tertiary amine compound.

10. The method of producing an ink cured product according to claim 9 wherein the tertiary amine compound is an aromatic tertiary amine compound.

11. An ink cured product, produced using the method of producing an ink cured product according to claim 1.

12. A printed item having a substrate and the ink cured product according to claim 11, wherein the substrate is either:
a paper having a property such that when the paper is secured to a mount having an angle of inclination of 50° and a single drop of 1,9-nonanediol diacrylate is dripped onto the paper from a 50 ml burette, the 1,9-nonanediol diacrylate flows at least 10 cm in 30 seconds, or
a plastic film.
